(19) United States
(12) Patent Application Publication
(10) Pub. No.: US 2006/0093709 A1
(43) Pub. Date: May 4, 2006

(54) Microwavable packaging of fresh produce

(76) Inventors: Robin Minter, Redcliffs (AU); Andrea Minter, Redcliffs (AU)

Correspondence Address: DINSMORE & SHOHL LLP, ONE DAYTON CENTRE, ONE SOUTH MAIN STREET, SUITE 1300, DAYTON, OH, 45402-2023, US

(21) Appl. No.: 10/520,692

(22) PCT Filed: Jul. 9, 2003
(86) PCT No.: PCT/AU03/00883

§ 371 Date: Aug. 22, 2005

(30) Foreign Application Priority Data
Jul. 9, 2002 (AU) 2002950053

(51) Int. Cl. A23B 7/148

(52) U.S. Cl. 426/106

(57) ABSTRACT

The present invention relates to a method of packing a fresh produce, such as for example, asparagus, in a package which prolongs the shelf life of the fresh produce to up to 6 weeks or more. The fresh produce is treated before being packed in the package. The package is microwavable so that the fresh produce can be cooked whilst remaining in the package. The advantage of the method and package of this invention is that the fresh produce is located within the package from farm to plate so that the package can be used to transport and store and produce as well as cooking the produce.

The present invention relates generally to packaging of products, particularly packaging of naturally occurring products, such as produce. More particularly, the present invention relates to the packaging of fresh fruit and vegetables in a manner which extends the shelf life of the fresh produce. Even more particularly, the present invention relates to methods of packaging fresh fruit and vegetables and to packages containing the fresh fruit and vegetables in which the package extends the shelf life of the fresh fruit and vegetables in storage and allows the produce to be cooked or heated whilst remaining in the package. The present invention particularly relates to a method of packaging fresh product in a microwavable package that allows the produce to be stored for a greater period of time than conventional methods of storing fruit or vegetables and then allows the produce to be cooked or heated in a microwave whilst still remaining in the package so that the fresh produce can be served directly from the package to the consumer, ie., the one package can be used from farm to table. The present invention finds particular application as methods of packaging, methods of storing and methods of cooking or heating fresh asparagus, particularly microwaving fresh asparagus, using the same packaging for storing and heating the asparagus which packaging is a modified interactive package that keeps the asparagus fresh for longer periods of time than loose asparagus or bunches of asparagus normally remain fresh.

Although the present invention will be described with particular reference to one form of a package for containing asparagus, which package is microwavable allowing the asparagus to be heated and/or cooked whilst remaining in the package and served directly from the package to the plate or to the consumer, it is to be noted that the scope of the present invention is not restricted to the describe embodiment or embodiments but rather the scope of the present invention is more extensive so as to include the use of other packaging for other products in other applications than those specifically described.

The population generally has an increased awareness of the benefits of a healthy lifestyle. Part of maintaining a healthy lifestyle is eating correctly. Accordingly, there is now a greater emphasis on eating fresh fruit and vegetables to not only maintain a healthy diet and lifestyle but also to combat the effects of debilitating conditions or diseases. It is thought that increased consumption of certain fresh fruits and vegetables can assist the body in combating the adverse effects of some conditions and/or diseases. Accordingly, there is a need to provide increased quantities of fresh fruit and vegetables and to be able to store the fresh fruit and vegetables for longer periods of time before spoilage or deterioration occurs.

Asparagus is included amongst the growing list of fresh fruit and vegetables being consumed in increasing amounts. However, there are a number of disadvantages to providing fresh asparagus using existing methods. Currently, fresh asparagus is only available as loose asparagus or as bunches of fresh asparagus, typically held together by a tie, band or similar, such as a rubber band. Although other forms of asparagus are available such as canned asparagus, pickled asparagus or frozen asparagus these forms are not fresh since the asparagus is preserved and thus, all of the health benefits of fresh asparagus may not be available from the preserved asparagus. Accordingly, the forms of the asparagus other than the fresh asparagus are less popular.

The problems of fresh asparagus are that bunches of fresh asparagus or loose asparagus have a short shelf life, typically as low as two weeks which is a big concern for retailers, such as supermarkets owing to the risk of spoilage of the fresh asparagus. Currently, there is an amount of wastage of fresh asparagus on supermarket shelves owing to handling and early expiry of use-by dates which results in a portion of the product being destroyed. This is costly for the supermarket and for the growers since supermarkets will not pay a premium price for asparagus that could have a short shelf life.

Conventionally, fresh asparagus has been transported as bunches of asparagus or as loose asparagus. However, there is a need to provide a method of packaging the asparagus which enables the asparagus to remain fresh for greater periods of time. Thus, there is a need to extend the shelf life or storage life of fresh asparagus.

Another problem of existing fresh asparagus relates to the size of the lengths of the asparagus that are available and cooking of the asparagus spears. If whole lengths of asparagus are to be cooked care must be taken to cook the asparagus evenly since whole lengths of asparagus will not cook evenly unless due care is taken because the tip cooks faster than the butt. Therefore there is a need for an improved or easier way of cooking asparagus which allows more or less uniform cooking.

Another problem associated with current ways of producing, distributing, marketing and supplying fresh asparagus is the way in which the fresh asparagus is distributed. Asparagus for export must be of a type, style, colour, size and quality that is acceptable to the export markets. An amount of asparagus that is currently produced does not meet these stringent export requirements.

Asparagus that does not meet export quality is currently not being utilised which increases the amount of asparagus that is wasted. Therefore, asparagus spears that are too short, bent, misshapen, or of the wrong size or shape are currently not being fully utilised but rather are being wasted. Currently, the farm wastage of asparagus is of the order of about 10%. It has been a concern for a long time that there is wastage of perfectly acceptable asparagus for no other reason that it is the wrong size, shape, colour or the like. Therefore, there is a need to provide additional ways of utilising non-export quality asparagus and to minimise the wastage of asparagus which will have the effect of providing more asparagus or reducing the cost of asparagus or both.

Another problem associated with bundles of asparagus or loose asparagus is that the full length of asparagus, the so called asparagus spears, when located in previously available packs or when in a suitable container are subjected to uneven cooking or heating as the tips of the asparagus spears cook faster than the butt of the spears. Also, the cost of providing full spears of asparagus would be too expensive and further, it is difficult to control the final weight of the package when using full spears. Processing cut pieces of asparagus is easier since such pieces are easier to handle and it is easier to control the weight of packs when using pieces of asparagus because of their smaller size.

It is an aim of the present invention to provide methods of packaging or harvesting asparagus which allows the asparagus to be packaged in such a manner so as to have an extended shelf life and to be more readily cooked. It is another aim of the present invention to provide a package in which the asparagus can be transported, stored, cooked and served directly to the consumer.

It is another aim of the present invention to provide a microwavable package for containing asparagus so that the asparagus is located in the package at the time of harvesting and remains in the package, even during cooking, until the asparagus is served directly to the final consumer.

According to one aspect of the present invention there is provided a method of packaging a product including the steps of picking or harvesting the product, treating the product whilst substantially fresh from harvest or picking so as to enhance the storage properties of the product, packaging the product in a package which extends the shelf life of the product wherein the package is microwavable such that the produce can be microwaved whilst in the packaging ready for serving directly to the consumer.

Typically the treatment includes treating the fresh or recently picked or harvested asparagus with cleaning preparations. More typically, the cleaning preparations include soaps, Neem oil or the like. Other cleaning methods include the use of ozone, ultrasonic techniques, sanitisers, such as chlorine, and the like. More typically, the treatment involves removal or elimination of thrip (a tiny harmless insect which hides in the bracts of the asparagus).

According to another aspect of the present invention there is provided a package containing a product when made by the process of the present invention.

Typically, the product is produce. More typically, the produce is fresh fruit and vegetables. Even more typically, the fresh fruit and vegetables include asparagus. Even more typically, the asparagus is fresh asparagus having no additives or artificial materials, such as for example, added preservatives, conditioners or the like.

Typically, the asparagus is provided in cut form or in a reduced size form. More typically, the reduced sized form includes pieces, chunks, lumps, slices or other forms. Even more typically, the asparagus is cut to a predetermined size to fit into the package and to be suitable for heating, cooking or the like. Even more typically, the size of the lengths of asparagus is determined by the diameter of the spears and can be controlled so that the tips of the asparagus need to be bigger than the more solid stem pieces to ensure that even cooking in the microwave occurs.

Typically, a sachet of sauce, salad dressing or the like is included in or with the package, such as for example, attached to the outside of the pack so that it can be removed prior to cooking. More typically, the sauce is hollandaise sauce, lemon pepper, mild mustard, lemon butter, balsamic, garlic butter or the like.

Typically, other products that can be packed include nuts and other vegetables, such as broccoli, carrots, cauliflower, mushrooms, beans or the like, and fruits such as grapes, oranges, citrus fruits, tangelos or the like.

Variations of fresh asparagus include tempura coated asparagus, deep fried battered asparagus or the like.

Typically, the package is a punnet. More typically, the punnet has a base made from polypropylene (PP) which material is microwave safe and environmentally friendly. Even more typically, the polypropylene has been adapted or modified for specific use with fresh fruit and vegetables, particularly asparagus.

Even more typically, the punnet is a package provided by Bantec International Pty Ltd of Victoria, Australia. More typically, the punnets are modified atmosphere punnets, typically micro atmospheric rigid packaging. Typically, the punnets are MIP punnets (Modified Interactive punnets) of the type allowing flow through of gases associated with the products and/or atmosphere of the punnet. More typically, the punnets have lids. Even more typically, the lids are made from PP, PVC, PET or similar materials, as such materials have desirable properties. A particularly preferred form of the punnet has both the base and the lid made from polypropylene. Even more typically, the punnet is certified as having FDA and NASSA approval for use with fresh food.

Typically, the packs are provided with tamper proof or tamper evident devices, labels or the like to ensure the contents of the pack have not been contaminated or interfered with in any way and/or provide a visual indication that interference has occurred. Examples include a wrap or wrapping of microwave-proof film covering the entire pack whilst allowing air flow through the pack, or heat shrink wrapping or the like.

Typically, the packages useful in the present invention creates naturally occurring movement of gases across and through the wall and base of the punnet. This allows an interaction to take place between the produce and gases such as oxygen, carbon dioxide and water vapour gaseous materials and the substrate to occur naturally thereby eliminating the need for mechanical or chemical interference. In contrast to other forms of packaging, this new technology allows the packed item to determine its own rate of gas exchange and molecular movement to create an environment that best suits the product. With correct temperature selection and control, the contents will remain fresh for days and weeks without spoilage, a common problem with conventional punnets and other packages. Typically, asparagus packed in accordance with the present invention remains fresh up to six weeks or even longer, preferably up to about 20 days or longer, and more preferably up to about 14 days or longer.

Typically, the punnets of the present invention enhance nutrient retention, reduce weight loss of the product during transportation, storage, distribution or the like and improve produce integrity for long periods. As fresh produce packed into the punnets can be preserved for long periods less handling is required thus eliminating the need for costly repacking. Additionally, there is less spoilage and/or wastage.

Typically, the package and method of packaging in accordance with the present invention provides pre-packed, ready-to-eat, heat and serve convenience foods that can be stored, distributed, transported, cooked, heated or the like in the same package without adverse effects on the product in the package.

Typically, the package in which the asparagus is packed and transported is also suitable for cooking the asparagus in, preferably microwaving the asparagus.

Typically, the packages in accordance with the present invention are provided for commercial sale, or use, domestic sale or use, for retail sale or the like.

Typically, the package of the present invention can be a ready to serve product either by adding a sauce sachet for putting into a microwave or with salads whereby salad sauces can be added. Another application is as an airline meal. It could also be used with fresh fruit where a sauce or custard could be included into the pack. The major benefits are that produce can be protected from outside contamination. Reduced handling of the product results in there being less chance of spreading infections, bruising, produce breakdown or the like, as well as insect elimination from the product owing to the product having to be packed under hygienic conditions substantially free from insect or other pest contamination, mainly thrip. Packing, according to the present invention reduces the incidences of cross contamination and improves vitamin retention. It also reduces weight loss and increases colour retention. It eliminates the need for soaker pads as used in berry fruits and grapes and it has been proven to be successful with table grapes for 6 weeks without the use of SO2 pads. It can be produced as a free standing punnet or as a hang cell pack or in any form of pack that is suitable, including combinations of two or more different forms.

The present invention will now be described by way of example with reference to the accompanying drawing and following examples, in which:

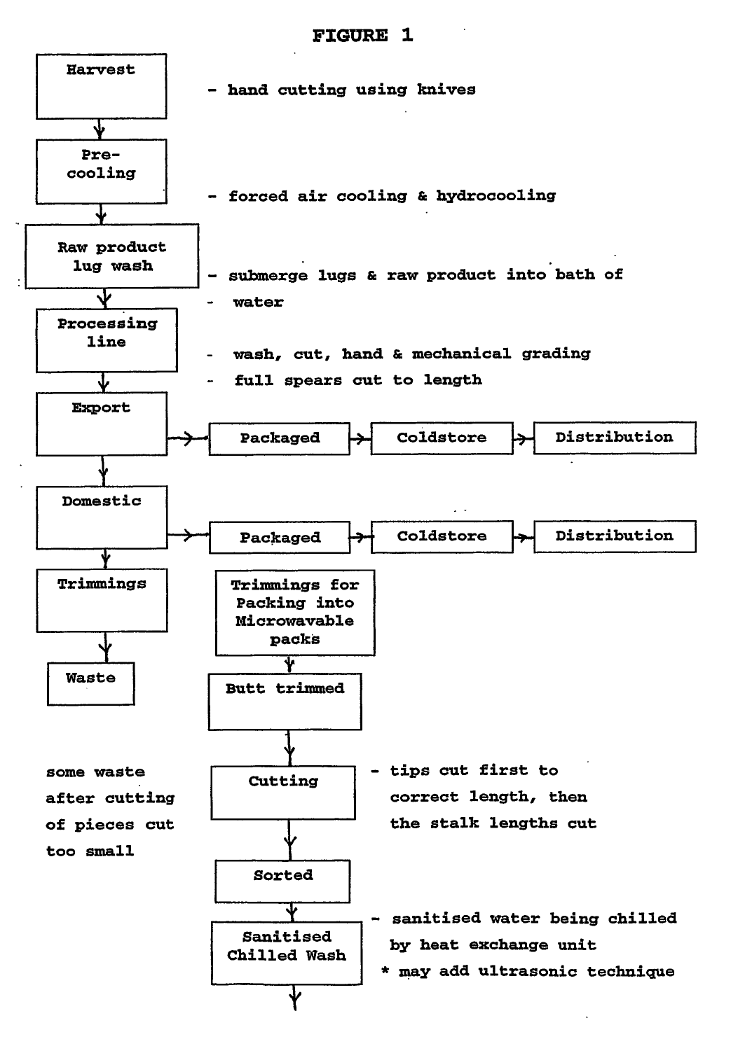

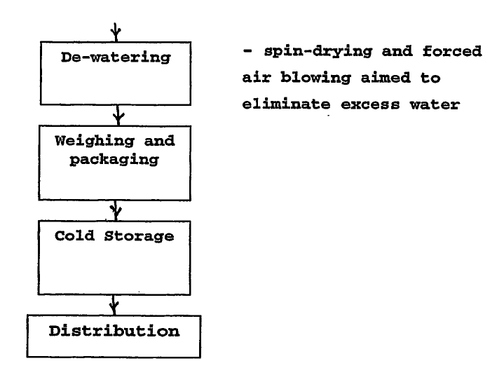

FIG. 1 is a flow diagram of one embodiment of the processing of the present invention showing the various alternatives for marketing asparagus, such as export, domestic or trimmings, and the method of packing trimmed asparagus in microwavable packs in accordance with the present invention.

### EXAMPLE 1

Asparagus plants after obtaining the required maturity are harvested. The asparagus is collected from the fields in which it is grown as spears of asparagus. The asparagus spears are then graded in accordance with their size, shape, colour or like properties or characteristics as being of export quality or for being suitable for distribution onto the domestic markets. In either case the asparagus is packaged and distributed accordingly.

If the asparagus is not suitable for either the export or domestic markets but otherwise is still of a high quality, the asparagus spears or other parts of the asparagus plants are cut to size so that the lengths or pieces of asparagus are of a more or less uniform size making packing easier. Typically, the lengths are cut using blades, knives or other suitable cutters or the like. The cutting can take place manually or it can be automated. Typically, the cut pieces are more or less the same size, particularly the same length.

It is to be noted that the sizes of the cut pieces of asparagus will depend on a number of factors which include butt diameter. As an example, a medium size spear will be cut to approximate lengths of the tip being about 65 mm and the spear 50 mm. Any suitable sized or diced asparagus pieces can be used, even if originally the length of asparagus was not of export quality.

After cutting, the lengths are washed to remove any contamination such as soil, grit, dirt, insects or other unwanted material. Typically, the lengths are washed in water, such as for example, submerging the product into water baths or similar.

After washing, the lengths of asparagus are further treated to increase their storage properties, appearance or other properties such as being chilled washed.

Typically, the other treatments include grading into size, weighing into lots, or the like.

The treated asparagus lengths or pieces are then de-watered using a current of air or similar. Typically, the de-watering is effected by using a current of air, spin-drying or combinations of both. If necessary, in some circumstances the air may be warmed. It is to be noted that any suitable device or method may be used to de-water the asparagus and that de-watering is affected by such factors as tip density, spear size, butt diameter, contact duration as well as atmospheric conditions.

Then the dried asparagus lengths or pieces are packed into suitable containers, such as MIP packages. Typically, one form of the package is an 18 cm×8 cm×4 cm modified interactive pack.

Typically, the excess moisture of the asparagus pieces is removed, such as for example, by spin-drying the cut pieces. The cut pieces are a mixture of tips and spear stems including butts, randomly packed into the pack in a controlled manner to have a preselected weight or weight range.

The present invention will be further illustrated with reference to the following results of trails conducted on packages of asparagus.

Trials were conducted in respect of samples of asparagus treated and packed in accordance with the description provided above. Details of this trail are as follows.

Trial Conditions:

Samples of produce were selected from the same asparagus batch that was harvested, treated, graded and sorted prior to packing and storage into a commercial cool room with a storage temperature set at from 3° C. to 5° C. to form the samples upon which this study was performed. The produce was subjected to the normal interruptions of daily activities with fresh cartoned products added at various intervals throughout the trial period creating temperature fluctuations in the trials.

The variety Of asparagus used in the trials Was: UC157 FI

SIZE: M

Pack Types:

MIP PACKAGE I: 20 mm deep slimline punnets. (Sample 1)

KIP PACKAGE II: 40 mm deep punnets. (Sample 2)

Standard bunched asparagus held together with rubber band at the trimmed end and wrap around label beneath the heads. (Sample,3)

Trial Duration:

Duration: 23 Days

Assessment Criteria:

A scoring system based on 0 to 10 was used to determine results with 5 being the minimum acceptable level for resale. A score of 10 was considered to be the best. The following areas formed part of the overall assessment. Storage temperature, weight loss, visual assessment, colour, butt dryness, condensation, stem oxidation, limpness, odour, taste, cooking test.

Results:

The temperature of storage Temperature: commenced at 3.2° C. and fluctuated throughout the trial period between 3° C. and 5° C. with the mean average temperature determined being 3.5° C.

Trial Data

The samples of asparagus tested were: Loose samples, Banded samples in a bunch & samples packaged in a Punnet.

| | DAY 1 | DAY 7 | DAY 15 | DAY 21 | DAY 23 | |
|---|---|---|---|---|---|---|
| WEIGHTLOSS | | | | | | |
| Punnets | | | | | | LOSS |
| 20 mm | 119 grm | 119 grm | 119 grm | 118 grm | 118 grm | 0.841% |
| 40 mm | 224 grm | 224 grm | 223 grm | 222 grm | 222 grm | 0.893% |
| Loose | 209 grm | 194 grm | 184 grm | 174 grm | 171 grm | 18.182% |
| Average | | | | | | |
| VISUAL ASSESSMENT | | | | | | |
| Punnets | | | | | | RESULTS |
| 20 mm | 10 | 10 | 10 | 10 | 10 | 10 |
| 40 mm | 10 | 10 | 9 | 8 | 8 | 9 |
| Loose | 10 | 9 | 6 | 4 | 3 | 6.4 |
| COLOUR | | | | | | |
| Punnets | | | | | | |
| 20 mm | 10 | 10 | 10 | 10 | 10 | 10 |
| 40 mm | 10 | 10 | 10 | 9 | 9 | 9.6 |
| Loose | 10 | 10 | 9 | 8 | 7 | 8.8 |
| LIMPNESS | | | | | | |
| Punnets | | | | | | |
| 20 mm | 10 | 10 | 10 | 10 | 10 | 10 |
| 40 mm | 10 | 10 | 10 | 10 | 10 | 10 |
| Loose | 10 | 10 | 6 | 4 | 3 | 6.6 |
| BUTT DRYNESS | | | | | | |
| Punnets | | | | | | |
| 20 mm | 10 | 10 | 10 | 9 | 9 | 9.6 |
| 40 mm | 10 | 10 | 10 | 9 | 9 | 9.6 |
| Loose | 10 | 8 | 7 | 4 | 4 | 6.6 |
| CONDENSATION | | | | | | |
| Punnets | | | | | | |
| 20 mm | 10 | 10 | 10 | 9 | 9 | 9.6 |
| 40 mm | 10 | 10 | 10 | 9 | 9 | 9.6 |
| 20 mm | 10 | 10 | 10 | 8 | 7 | 9 |
| abuse | | | | | | |
| test | | | | | | |
| Loose | not applicable | | | | | |
| STEM OXIDATION | | | | | | |
| Punnets | | | | | | |
| 20 mm | 10 | 10 | 10 | 10 | 10 | 10 |
| 40 mm | 10 | 10 | 10 | 10 | 10 | 10 |
| Loose | 10 | 10 | 10 | 10 | 10 | 10 |
| ODOUR | | | | | | |
| Punnets | | | | | | |
| 20 mm | 10 | 10 | 10 | 10 | 10 | 10 |
| 40 mm | 10 | 10 | 10 | 10 | 9 | 9.8 |
| Loose | 10 | 10 | 10 | 10 | 10 | 10 |
| TASTE | | | | | | |
| Punnets | | | | | | |
| 20 mm | 10 | 10 | 10 | 10 | 9 | 9.8 |
| 40 mm | 10 | 10 | 10 | 9 | 8 | 9.4 |
| Loose | 10 | 10 | 9 | 8 | 8 | 9 |
| COOKING TEST | | | | | | |
| Punnets | | | | | | |
| 20 mm | 10 | n/a | n/a | n/a | 9 | 9 |
| 40 mm | 10 | n/a | n/a | n/a | 9 | 9 |

| | |
|---|---|
| Loose | not applicable |

Abuse Test:

One 20 mm punnet was removed from the trial on day 16 of the trial and subjected to ambient temperature abuse ranging from 18° C.-22° C. for six hours. Produce was then chilled for two days in cold storage at a different location at 2.2° C. then exposed to ambient temperature for one hour at 16° C. then returned back to the trial coolroom at 3.0° C.

The trial of this punnet continued but ceased at day 21 as it was considered the produce only rated a five which is the lowest value of acceptability of the asparagus sample under test. Tips showed signs of degradation. Spears had visual cell breakdown with part of the stems in total collapse. Slight odour present but not anaerobic.

O₂,CO₂ Tests:

Scientific tests conducted by (Kader and Morris 153) confirm that minimum O₂ levels of 5% can be tolerated by Asparagus. Maximum CO₂ levels of 10% can be tolerated. Kader and Morris also point that other factors may cause quality deterioration and that tolerance levels may vary due to storage temperature, cultivar, produce maturity, age and post harvest quality.

However (Ryall and Lipton 1960) and (Weichmann 1968) are able to expand further by recommending minimum and maximum safe tolerances as follows:

Safety margins for CO₂ are 5% to 9% and 5% to 20% for O₂. These minimum maximum levels set the benchmark for growers and packers to regularly test their produce and ensure that no asparagus are delivered to resellers outside these safety requirements.

Tests Conducted:

Equipment: Novetech Controls Pty Ltd Model 1637

Results:

The sample used for testing had been the temperature abused trial punnet number 3, referred to earlier, as it was considered to be the worst case scenario.

| | |
|---|---|
| 0₂ reading: | 9.8% |
| CO₂ reading: | 8.5% |

The results of the tests conducted on the trial produce confirm that the MIP punnets are able to preserve Asparagus safely within the tolerances recommended and thus illustrate the efficiency of using the method and package of the present invention. Clearly, treating asparagus in accordance with the method of the present invention and packing the asparagus pieces into a suitable microwavable package such as an MIP package preserves the freshness of the asparagus beyond the conventional shelf life of loose asparagus and allows the asparagus to be heated, particularly in a microwave, so that the asparagus can be served directly from the package to the plate.

### CONCLUSION

The trials conducted clearly support the use of the punnets of the present invention and provide real improvement to the way asparagus could be presented for local and export markets. The weight loss saving of 18% is remarkable. The punnets clearly improve produce outturn and provide an effective method of moisture retention without condensation on the lid. The punnets protect produce from external contamination and could be sealed with tamper evident packaging labels. From a grower perspective the opportunity is now available to offer a “value added pack” to clients/customers/consumers. The package can be lengthened if required to reduce produce wastage.

When in the MIP pack the asparagus can be transported, stored, distributed or the like as required whilst remaining fresh and maintaining flavour and nutrients. Further, the packs of asparagus can be displayed for sale in supermarkets or the like. Owing to the extended shelf life of the packs the asparagus is still fresh and visually appealing in the pack, even after many weeks, and certainly beyond the 14 days of conventionally available asparagus. Studies have revealed that the asparagus can remain fresh for up to about six weeks or even longer, which is well beyond the normal 14 days. After purchase, the pack can be placed in a microwave and heated thereby cooking and/or heating the asparagus in the pack with or without added sauces or the like. The heated asparagus can then be served directly from the pack to the plate or similar thereby providing a convenient way of both storing and cooking the asparagus using the one pack which can be used from farm to plate, thus enjoying considerable advantages.

The packaging process including the steps prior to actually packing the asparagus, permits the asparagus to be packed fresh and the modified or interactive atmosphere resulting in the pack ensures the freshness of the asparagus for a longer period of up to about six weeks in comparison to the normal two week period the fresh bunched asparagus will remain fresh.

The nature of the MIP pack allows the pack containing the asparagus to be heated/cooked in the microwave. This means that without taking the asparagus out of the pack it can become a prepared meal in about two minutes. The simplicity of storing and heating the asparagus using the method of the present invention means that asparagus will be accessible to many more consumers, thereby increasing the size of the existing market and creating an entirely new market in fresh microwavable asparagus.

One of the contributing factors to the benefit of the present invention is the reduction in weight loss of the asparagus on storage to a figure of about 18% as compared to bunches of fresh asparagus. From a consideration of the values provided in Table 1 referred to earlier in the trial of Example 1 of this specification it can be seen that the weight loss of loose asparagus after 23 days is about 18% whereas the weight loss after 23-days for asparagus packed in accordance with the present invention is about 0.8% or 0.9%. Thus, there is a considerable reduction in weight loss using the present invention.

The use of the modified interactive packages extends the shelf life of the fresh asparagus for up to about six weeks. The shelf life of the asparagus packed in accordance with the present invention is greatly extended and improved over the shelf life of conventional loose packed bunched asparagus.

Using the present invention it is possible to supply fresh fruit and vegetables, particularly asparagus for 12 months of the year.

Other advantages include that asparagus is able to be delivered by alternative less costly means, such as for example by sea freight rather than air freight which is expensive, thereby increasing sales in existing markets and opening new markets for higher profit. The longer shelf life will encourage additional retailers to stock the asparagus because there is a greater length of time to sell the product which lessens the risk of the product being unsold by its use-by date.

Advantages of the present invention include the following. The process and package of the present invention allows non-export quality asparagus to be utilised in a way that has not been possible before and in which the asparagus can still be sold as a premium product even if it is not of export quality. Further, the fresh product, particularly asparagus, can be cooked in the package.

The described arrangement has been advanced by explanation and many modifications may be made without departing from the spirit and scope of the invention which includes every novel feature and novel combination of features herein disclosed.

Those skilled in the art will appreciate that the invention described herein is susceptible to variations and modifications other than those specifically described. It is understood that the invention includes all such variations and modifications which fall within the spirit and scope.

1-41. (canceled)

42. A method of packaging a fresh product including the steps of:
harvesting the product while fresh;
treating the product while substantially fresh from harvest in order to enhance the storage properties of the product;
packaging the product into a package which extends the shelf life of the product;
characterized in that the package is microwavable such that the produce can be heated in a microwave while in the package so as to be ready for serving directly to the consumer from the package, and in that there is naturally occurring movement of gases within the package thereby allowing interaction to take place between the product located within the package and gases in the atmosphere in order to eliminate the need for mechanical or chemical interference of the product in the package.

43. A method according to claim 42, characterized in that heating of the product includes steaming the product in the microwavable package using a microwave and serving the package onto the table ready for consumption.

44. A method according to claim 42, characterized in that the method further includes treating the fresh or recently picked or harvested product with one or more cleaning steps to enhance the organoleptic and/or storage properties of the product.

45. A method according to claim 44, characterized in that the cleaning step includes contacting the product with a cleaning preparation that includes soaps, Neem oil or the like.

46. A method according to claim 44, characterized in that the cleaning step includes the use of ozone, ultrasonic techniques, sanitizers, chlorine or the like, either alone or in combination.

47. A method according to claim 44, characterized in that the cleaning treatment involves removal or elimination of thrip and/or other unwanted insect, disease condition or the like.

48. A package containing a product when made in accordance with the process of claim 42.

49. A method according to claim 42, characterized in that the product comprises fresh fruit or vegetables.

50. A method according to claim 49, characterized in that the fresh fruit or vegetable is asparagus.

51. A method according to claim 50, characterized in that the asparagus is fresh asparagus having substantially no additives or artificial materials added to it either before, during or after processing.

52. A method according to claim 48, characterized in that the package comprises a punnet, container or tray.

53. A method according to claim 52, characterized in that the punnet is made from a plastics or synthetic material or a combination thereof.

54. A method according to claim 53, characterized in that the punnet includes a base and a lid, wherein the base is made from a propylene-containing material.

55. A method according to claim 54, characterized in that the polypropylene base has been adapted or modified for specific use with fresh fruit or vegetables.

56. A method according to claim 52, characterized in that the punnet has a modified atmosphere, a modified micro-atmosphere or is a Modified Interactive punnet.

57. A method according to claim 56, characterized in that the punnet is a Modified Interactive punnet of the type allowing flow through of gases associated with at lest one of the products or atmosphere of the punnet to enhance at least one of the storage or organoleptic properties of the product.

58. A method according to claim 54, characterized in that the lid is made from a polypropylene material, a polyvinyl chloride material or a polyethylene terapthalate material.

59. A method according to claim 54, characterized in that the lid and base of the package is made from a polypropylene-containing material.

60. A method according to claim 52, characterized in that the package creates naturally occurring movement of gases across and through the walls and base of the punnet, thereby allowing interaction to take place between the product located within the package and gases in the atmosphere within the package in order to eliminate the need for mechanical or chemical interference or modification of the product.

61. A method according to claim 60, characterized in that the gases in the atmosphere include oxygen, carbon dioxide, water vapor or the like.

62. A method according to claim 61, characterized in that the gases in the atmosphere include oxygen of greater than 5%, carbon dioxide up to 10%.

63. A method according to claim 62, characterized in that the amount of oxygen is between 5% and 20%, and the amount of carbon dioxide is between 5% and 9%.

64. A method according to claim 50, characterized in that the asparagus packed in accordance with the present invention using the package of the present invention remains fresh for up to about six weeks.

65. A method according to claim 50, characterized in that the asparagus packed in accordance with the present invention using the package of the present invention remains fresh for up to about 20 days.

66. A method according to claim 50, characterized in that the asparagus packed in accordance with the present invention using the package of the present invention remains fresh for up to about 14 days.

67. A method according to claim 42, characterized in that the package enhances nutrient retention and reduces weight loss of the product during transportation, storage and distribution to less than about 1%.

68. A method according to claim 48, characterized in that the method and package provides pre-paced, ready-to-eat, eat-and serve convenience foods that can be stored, distributed, transported, cooked, heated or the like in the same package with substantially no adverse effects on the product in the package.

69. A method according to claim 48, characterized in that the package includes a ready-to-serve product in combination with a sauce sachet.

70. A method according to claim 52, characterized in that the punnet is a free standing punnet or a hang-cell pack.

71. A method according to claim 50, characterized in that the asparagus useful in the packaging is non-export quality.

72. A method according to claim 50, characterized in that the spears of asparagus are cut to a predetermined or preselected length.

73. A method according to claim 72, characterized in that after cutting, the length of asparagus are washed.

74. A method according to claim 73, characterized in that after washing, the spears of asparagus are further treated to increase their storage properties, appearance or other properties by being chill-washed.

75. A method according to claim 74, in which the treated asparagus spears are dewatered using a current of gas.

76. A method according to claim 50, characterized in that the asparagus is provided in one or more cut forms or in a reduced size form, including pieces, chunks, lumps, slices, lengths or spears.

77. A method according to claim 76, characterized in that the asparagus is cut to a predetermined size to fit into the package.

78. A method according to claim 76, characterized in that the size of the asparagus is determined by the diameter of the spears and can be controlled so that the tips of the asparagus need to be bigger than the more solid stem pieces.

79. A method according to claim 42, characterized in that the fresh product is selected from the group consisting of nuts, broccoli, carrots, cauliflower, mushrooms, beans, grapes and citrus fruits.

80. A method according to claim 48, characterized in that the packages are provided with tamper-proof or tamper-evident devices.

81. A method according to claim 42, characterized in that the fresh product is subjected to a dewatering step.

82. A method according to claim 81, characterized in that the dewatering step is effected by using at least one of a current of air, spin drying, or a combination of both.

83. A method according to claim 81, characterized in that excess moisture is removed from the fresh product by the dewatering step.
